(19) United States
(12) Patent Application Publication
(10) Pub. No.: US 2009/0287545 A1
(43) Pub. Date: Nov. 19, 2009

(54) System and method for computer program implemented internet digital music marketplace

(76) Inventor: Nicholas A. Albright, Winter Park, FL (US)

Correspondence Address: THE MILLER LAW OFFICES, PLC, 801 BRICKELL AVE, SUITE 900, MIAMI, FL, 33131, US

(21) Appl. No.: 12/464,849

(22) Filed: May 12, 2009

Related U.S. Application Data
(60) Provisional application No. 61/052,989, filed on May 13, 2008.

(51) Int. Cl. G06Q 10/00; G06Q 30/00; G06Q 50/00; G06Q 20/00

(52) U.S. Cl. 705/10

(57) ABSTRACT

A system and method for modeling and implementation of a computer program to provide an individual artist the ability to access a system for marketing music on the website, a fan voting system, an artist rating system, an artist award system, music genre chat rooms that play random tracks from the digital music store, the optional ability for multiple artists to post their live concerts, the ability for multiple artist to post tour schedules, music tournaments, charts, a digital music store that allow producers the ability to upload their instrumentals and sell them in a auction style listing, and a digital music store that gives multiple artist the ability to upload their music for sale with full control of their music's pricing and marketing. Said computer implemented system and method may be implemented on a single stand alone computer, or a computer terminal connected to a global public network.

### CROSS REFERENCE TO RELATED APPLICATIONS

This application claims priority from U.S. Provisional Application No. 61052989, filed on May 13, 2008.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

1. Field of the Invention

The system and method described below relates to modeling and implementation of an internet based computer program that comprises an ad system for marketing music on an website, together with user registration, a user voting system, an artist rating system, an artist award system, music genre chat rooms that play random tracks in that specific genre from the digital music store, the ability for multiple user artists to post their live concerts, the ability for multiple user artists to post tour schedules, music tournaments, charts, a digital music store that allows producers the ability to upload their instrumentals and sell them in a auction style listing, and a digital music store that gives multiple artist the ability to upload their music for sell with full control of their music's pricing and marketing, through said on-line internet website.

2. Prior Art

In the prior art an individual was able only to download or play music on a number of internet websites, but the users were limited to said internet on-line activities. Also, music producers and artists needed to go through a few record label companies to have any chance at publishing their artistic works for exposure and review by the general public. Objectives for this invention is to solve the problem the music industry has had in moving digital technology on to the internet. This invention improves the music industry's business in such a way that as to expand the music industry well beyond a few major record labels, and thereby create a level playing field for all artists, producers, and record labels. This will bring in more money to the music industry because it will be easier for new artists to get into the industry thereby enhancing the chances at being successful. This invention will also cut cost in production of digital compact discs and in the cost of marketing, thereby saving the industry even more money. This invention will maximize the sale of exclusive instrumentals by creative producers thereby adding more value to the producers creativity. Most important is that the invention will operate on consumer demand. These novel advantages and features are something the music industry has not envisioned and this invention will change the future of the music industry and create enthusiasm about the said industry in the internet era. The music consuming public want to hear music they enjoy and not what is forced on them. In this invention, the consumer will tell the music industry what it likes and doesn't like by voting and spending their money where they choose thereby assisting record labels in observing which artists and producers are best to associate with. In this way, the public obtains better music that the consumer does not mind paying for. Also to reward the artists and producers for their creativity and to help with declining profits of digital compact discs (“CD's”) the invention is able to conduct a music tournament that rewards the top tier of artists with a portion of the on-line admission fees and with largest portion going to the winner. The invention is based all on the consumers demand. Accordingly, what is needed is a system and a method implemented by a computer program, through a stand-alone computer or a computer network coonected to the world wide web internet, which enables an individual to ability to access a system for marketing music on the website, a fan voting system, an artist rating system, an artist award system, music genre chat rooms that play random tracks from the digital music store, the optional ability for multiple artists to post their live concerts, the ability for multiple artist to post tour schedules, music tournaments, charts, a digital music store that allow producers the ability to upload their instrumentals and sell them in a auction style listing, and a digital music store that gives multiple artist the ability to upload their music for sale with full control of their music's pricing and marketing. This invention resolves these prior deficiencies.

### SUMMARY OF THE INVENTION

The system and method disclosed in the preferred embodiment can be implemented on any computer or computer terminal which is connected to a single computer or computer network connected to a global public network such as the world wide web, wherein said system and method which will enable an individual the ability to access a system for marketing music on the website, a fan voting system, an artist rating system, an artist award system, music genre chat rooms that play random tracks from the digital music store, the optional ability for multiple artists to post their live concerts, the ability for multiple artist to post tour schedules, music tournaments, charts, a digital music store that allow producers the ability to upload their instrumentals and sell them in a auction style listing, and a digital music store that gives multiple artist the ability to upload their music for sale with full control of their music's pricing and marketing.

The coded environment gives multiple artist and producers the ability to upload their music, or optionally their music video, whether in a single unit or multiple units (like an album) into the digital music store, then said digital media to be downloaded at what ever price, time length, and playback limit they choose to sell and market for. The ad system for marketing music on website that states how much time a registered user gets for your money on the website. (ex. For a user's didgital media track to stay on the site for a month the user must pay a small fee on-line). This invention features a music tournament that involves music instrumentals, tracks, and videos where artist can earn money by entering on-line. The invention further features music genre chat rooms that play random tracks from the digital music store and allows fans to chat and vote at the same time. Optionally, the invention provides the ability for multiple artists to post their live concerts unique to the music community website. The invention also comprises a music fan voting system that rewards fans credit for voting on instrumentals, tracks, and videos, an artist rating system that shows how artist are progressing through their online music careers, and an artist reward system that rewards artist with tournament credits for votes received from fans. The invention further comprises the ability to ascertain the best instrumental, best track, best video, best artist, best producer, and best label charts, and allowing the creation of a Halls of Fame for the aforesaid instrumentals, tracks, videos, artists, producers and charts. The invention comprises the ability to generate charts dealing with sales, votes, and plays.

In one embodiment, the system will allow an individual computer program user to first register on-line, said user will be able to select from the options of a buying songs or tracks from all over the world, selling the user's own music at the user's own set price, being ranked against other user artists around the world, chating with other user's and instant messaging with them, voting for the user's favorite artist and also earn credit, using the voting system to vote for the user's favorite artists in said user's industry, entering into tournaments to earn money, and promoting their own songs by posting bulletins and other information. Said selections comprise a voting system, an artist rating system, an artist award system, music genre chat rooms that play random tracks in that specific genre from the digital music store, the ability for multiple user artists to post music tournaments, charts, a digital music store that allows producers the ability to upload their instrumentals and sell them in a auction style listing, and a digital music store that gives multiple artist the ability to upload their music for sell with full control of their music's pricing and marketing, through said on-line internet website. The embodiment comprises an optional ability to posr concert schedules. The invention provides for electronic banking transfers to and from a user designated bank account, and on-line payments with credit and debit cards, and transfers with a Paypal® and other similar banking systems, as may be required.

### DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

In the drawings:

FIG. 1 is a block diagram of the basic main initial sequential process that an individual would effect in practicing one embodiment of the invention.

FIG. 2 is an exemplary illustration of the display of the first and opening page of the computer program in practicing one embodiment of the invention.

FIG. 3 is a block diagram of the detail of a subpart of the sequential processes for an individual user registration, an individual user's buying process and an individual user's selling process that is effected in practicing one embodiment of the invention.

### DETAILED DESCRIPTION OF THE EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

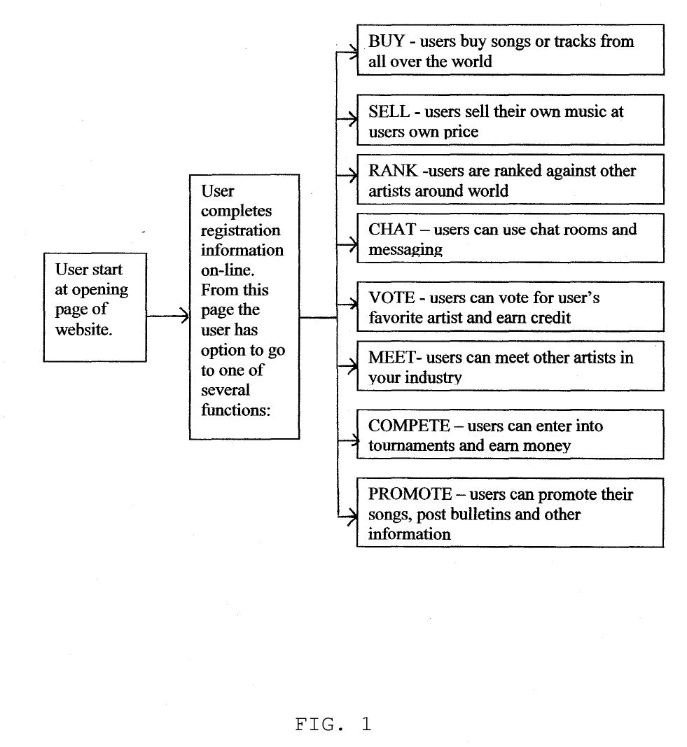

Reference will now be made in detail to an exemplary embodiment of the system, an example which is illustrated in the accompanying drawings (FIGS. 1, 2 and 3).

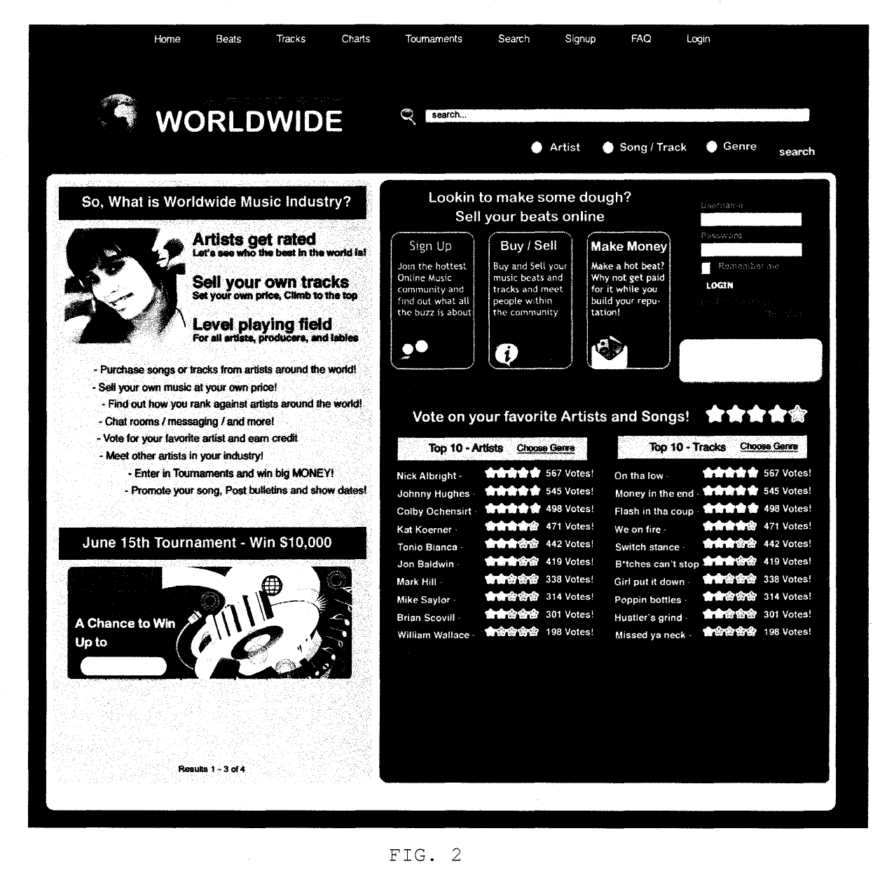

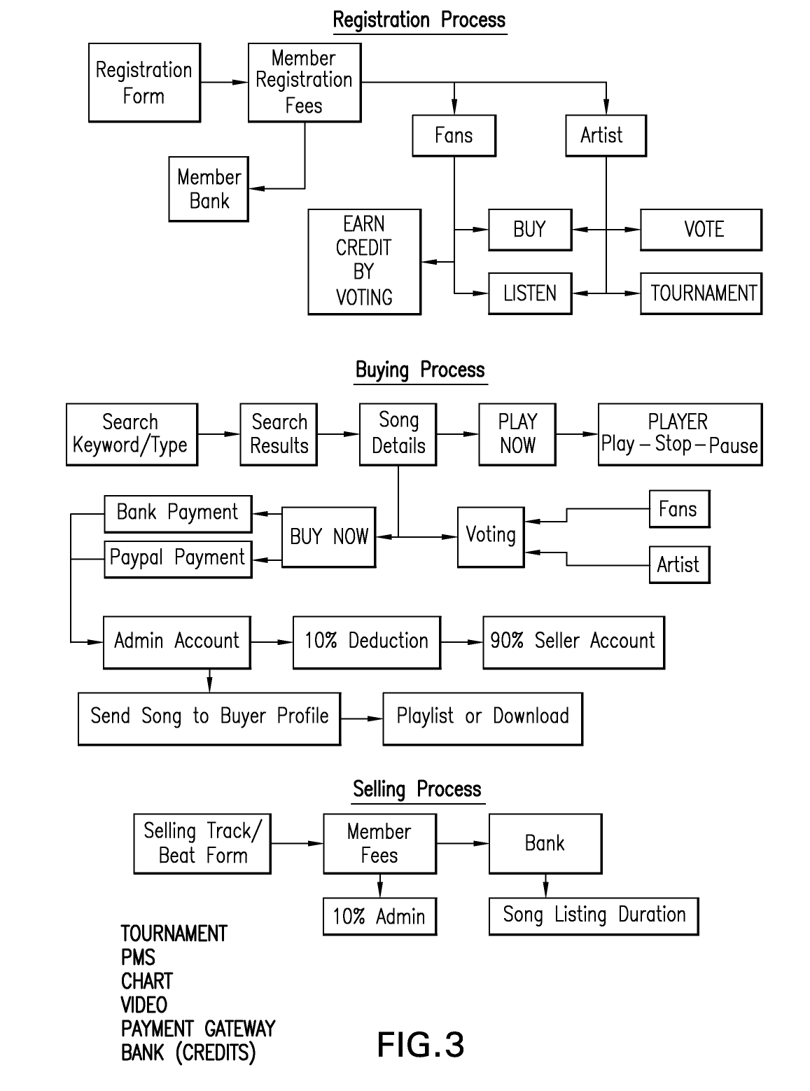

FIG. 1 is a block diagram of the sequential process that an individual would effect in practising one embodiment of the invention. It describes the logical sequence that an individual user or customer would encounter in the process of proceeding through the computer program appearing on a global public network website. A user or customer would enter a website, obtained by knowing the domain name or by obtaining said domain name through a search engine, and said user or customer would start at the opening page of website depicted by FIG. 2. From this page, the user would select “register”, and using the computer cursur positioning device, such as a mouse, the user would click on said webpage choice. said user will then be able to select from the options of a buying songs or tracks from all over the world, selling the user's own music at the user's own set price, being ranked against other user artists around the world, chating with other user's and instant messaging with them, voting for the user's favorite artist and also earn credit, using the voting system to vote for the user's favorite artists in said user's industry, entering into tournaments to earn money, and promoting their own songs by posting bulletins and other information. Said selections comprise a voting system, an artist rating system, an artist award system, music genre chat rooms that play random tracks in that specific genre from the digital music store, the ability for multiple user artists to post music tournaments, charts, a digital music store that allows producers the ability to upload their instrumentals and sell them in a auction style listing, and a digital music store that gives multiple artist the ability to upload their music for sell with full control of their music's pricing and marketing, through said on-line internet website. The embodiment comprises an optional ability to post concert schedules. This embodiment of the invention provides for electronic on-line payments as may be required. FIG. 3 is a block diagram of the detail of a subpart of the sequential processes for an individual user registration, an individual user's buying process and an individual user's selling process that is effected in practicing one embodiment of the invention. Through the registration process, the user could electronically pay said user's membership fees, and also access said member's own secure bank account. This embodiment allows to user to utilize electronic bank transfers, Paypal®, credit cards and debit cards.

In so far as the description above and the accompanying drawings disclose any additional subject matter that is not within the scope of the claims below, the inventions are not dedicated to the public and the right to file one or more applications to claim such additional inventions is reserved.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention.

What is claimed is:

1. A method implemented by a computer program running on a computer, the method comprising:
an individual user entering the opening display page of said computer program, said opening page providing said user the option of deciding to register on-line,
said individual user choosing to register then said program displaying a subsequent page, said subsequent page providing said user the option of enabling said individual the ability to access a system for marketing said user's music on the website, the option for said user of entering an on-line voting system for user's favorite artists, the option for said user of entering an on-line user artist rating system, the option for said user of entering an on-line artist award system, the option for said user of entering on-line music genre chat rooms that play random tracks from the digital music store, the option for said user to post said user's live concerts, the option for said user to post said user's tour schedules, the option for said user to post said user's music tournaments, the option for said user to post said user's charts, the option for said user to enter a digital music store that allow the upload of said user's instrumentals for sale in an auction style listing.

2. A method according to claim 1, wherein said computer program is running on a single stand alone computer.

3. A method according to claim 1, wherein said computer program is running on a private computer network.

4. A method according to claim 1, wherein said computer program is running on a world wide web based internet public computer network.

5. A method according to claim 1, wherein said computer program transmits payment, billing and shipping information through said computer program, using commercially available on-line payment systems.
